(19) United States
(12) Patent Application Publication
(10) Pub. No.: US 2005/0108852 A1
(43) Pub. Date: May 26, 2005

(54) Locking device for foldable rigid buckling packing housings

(76) Inventor: Li Huiquan, Nanhai City (CN)

Correspondence Address: KNOBLE YOSHIDA & DUNLEAVY, LLC;Suite 1350, Eight Penn Center, 1628 John F. Kennedy Blvd., Philadelphia, PA, 19103, US

(21) Appl. No.: 10/802,174

(22) Filed: Mar. 17, 2004

(30) Foreign Application Priority Data
Jun. 25, 2003 (CN) 03266954.2

(51) Int. Cl. E05D 11/10

(52) U.S. Cl. 16/327

(57) ABSTRACT

The present invention relates to a locking device for foldable rigid buckling packing housings, which has a lower housing and an upper housing hinging to each other, wherein the hinge between the upper housing and the lower housing has a structure as following: an upper housing hinge plate is attached on the upper housing; the upper housing hinge plate is interconnected with the lower housing hinge plate; a locking plate is installed on the lower housing to lock the rotatable arms of the upper housing hinge plate in both clockwise and anticlockwise direction; the locking plate is linked to a button on the side wall of the lower housing; the button has a resetting spring. The present invention makes the foldable rigid buckling packing housings able to be locked in both closed position and open position, and makes the structure simple and the device easy to use.

### BACKGROUND OF THE INVENTION

1. Field of the Invention

The present invention relates to a locking device for foldable rigid buckling packing housings, and particularly to a locking device that can be locked when the housings are open.

2. Description of Related Technology

Existing locking devices configured for foldable rigid buckling packing housings, or cases, can only be locked closed and cannot be locked open. Therefore, some rigid housings, or cases, which can only be used in an open position, cannot be used in a stable manner. Hence, existing locking devices for foldable rigid buckling packing housings still have some shortcomings, which need to be addressed.

With respect to the shortcomings of existing locking devices, it is an object of the invention to provide a mechanism that can be locked when a foldable rigid buckling packing housing, or case, is open.

### SUMMARY OF THE INVENTION

It is an object of the present invention to overcome the shortcomings of existing locking devices for foldable rigid buckling packing housings by providing a locking device for foldable rigid buckling packing housings with new structure. The technical problem that needs to be solved is enabling the device to be locked at an open position. It is also important to make the device easy to use, and to simplify the structure of the device.

In order to accomplish the object of the present invention and to solve the main problems, the following technical solutions were employed. According to a first aspect of the invention, a locking device for a foldable rigid buckling packing housings is provided, which includes a lower housing, an upper housing, a button, a lower housing hinge plate, an upper housing hinge plate and a locking plate, wherein the lower housing and the upper housing are interconnected by hinge plates. The hinge structure is implemented in the following way. An upper housing hinge plate is attached on the upper housing jointing and a lower housing hinge plate is attached on the lower housing. A movable locking plate is attached on the lower housing to lock the rotatable arms of the lower housing hinge plate. The movable locking plate is linked to the button on the lower housing and the button has a resetting spring.

The object of the present invention and the solving of technical problems can also be accomplished by employing the following technical solutions.

According to a second aspect of the invention, a locking device for foldable rigid buckling packing housings, wherein the upper side of the locking plate sticks at a lower edge of the upper housing hinge plate, which covers both sides of the projection of a hinge point. The distances between the hinge point and the lower edge, the inner edge and the upper edge of the upper housing hinge plate are the same as each other.

According to a third aspect of the invention, a locking device for foldable rigid buckling packing housings, wherein the lower edge of a upper housing hinge plate is parallel to its upper edge, while the inner edge is perpendicular to a lower edge.

According to a fourth aspect of the invention, a locking device for foldable rigid buckling packing housings, wherein a locking plate has a convex portion on its upper side outside a projection of a hinge point. An upper housing hinge plate has a concave portion on its lower side matching the convex portion on the locking plate. The distance between the hinge point and the concave portion is equal to the distance between the hinge point and the lower edge, the inner edge and the upper edge of the upper housing hinge plate.

According to a fifth aspect, a locking device for foldable rigid buckling packing housings, wherein a lower housing and upper housing both have a heating board; electrothermal components are installed between the housings and the heating board; a control knob is set on the outer side walls of the lower housing and the upper housing; feet are installed on both the bottom wall of the lower housing and the top wall of the upper housing.

Compared to existing technology, the present invention has significant advantages. As shown by the technical solution disclosed above, in order to accomplish the object of the present invention. The hinge joint between the upper housing and the lower housing has the following structure. Attach an upper housing hinge plate on an upper housing interconnected with a lower housing hinge plate attached on a lower housing; a movable locking plate is installed between a scaleboard of the lower housing and a fasten bar to lock the rotatable arms of the upper housing hinge plate; the movable locking plate is linked to the button on the lower housing; the button has a resetting spring. The present invention functions as following. Under normal circumstances, the movable locking plate can lock the rotatable arms of the upper housing hinge plate to stop them from rotating. The movable locking plate can lock the relative opening angle between the lower housing and the upper housing. When pressing the button to take it off the linked locking plate, the rotatable arm of the upper housing hinge plate is released, and the upper housing can rotate with respect to the lower housing through the hinge plate. Releasing the button when the opening angle between the upper housing and the lower housing reach a certain degree, the button will then be reset by a resetting spring and the locking plate locks the rotatable arms of the upper housing hinge plate again to stop them from rotating and lock the upper housing at that position.

The present invention is used with foldable rigid buckling packing housings. The foldable rigid buckling packing housings can be locked in a closed position and can be locked in an opened position.

In conclusion, according to the present invention, the special structured locking device for foldable rigid buckling packing housings has many advantages and is of great practical value. The invention also provides a remarkable technical improvement and generates practical and easy-to-use effects. In addition, the invention provides several additional beneficial features when compared to existing locking device technology for foldable rigid buckling packing housings. This makes the invention more desirable to use and more valuable for mass production.

The above and other features and advantages of the present invention will become readily apparent to those skilled in this art from the following detailed description wherein the preferred embodiment of the invention has been shown and described by way of illustration. As will be realized, the invention is capable of modification in various obvious respects all without departing from the invention. Accordingly, the drawings and description of the preferred embodiments are to be regarded as illustrative in nature, and not as restrictive.

### BRIEF DESCRIPTION OF THE DRAWINGS

FIG. 1 is a block diagram of a locking device for foldable rigid buckling packing housings in a closed position.

FIG. 2 is a block diagram of a locking device for foldable rigid buckling packing housings in a half open position.

FIG. 3 is a block diagram of a locking device for foldable rigid buckling packing housings fully opened to a 180-degree position.

FIG. 4 is a top down view of the block diagram in the B direction as shown in FIG. 3. FIG. 5 is a block diagram of the button in direction as shown in FIG. 3.

FIG. 6 is a block diagram illustrating the relative position of the upper housing hinge plate and the locking plate in a first embodiment while the locking device for foldable rigid buckling packing housings is closed, as shown in FIG. 3.

FIG. 7 is a block diagram illustrating the relative position of the upper housing hinge plate and the locking plate in a first and third embodiment while the locking device for foldable rigid buckling packing housings is half opened, as shown in FIG. 3.

FIG. 8 is a block diagram illustrating the relative position of the upper housing hinge plate and the locking plate in a first and third embodiment while the locking device for foldable rigid buckling packing housings is fully opened to a 180-degree position, as shown in FIG. 3.

FIG. 9 is a block diagram illustrating the relative position of the upper housing hinge plate and the locking plate in a second embodiment while the locking device for foldable rigid buckling packing housings is closed.

FIG. 10 is a block diagram illustrating the relative position of the upper housing hinge plate and the locking plate in a second embodiment while the locking device for foldable rigid buckling packing housings is half opened.

FIG. 11 is a block diagram illustrating the relative position of the upper housing hinge plate and the locking plate in a second embodiment while the locking device for foldable rigid buckling packing housings is fully opened to a 180-degree position.

FIG. 12 is an elevational drawing of the upper housing hinge plate.

FIG. 13 is a block diagram further illustrating the locking match between the upper housing hinge plate and the locking plate.

### DETAILED DESCRIPTION OF THE PREFERRED EMBODIMENT(S)

While the invention can be subject to various modifications and alternative constructions, certain illustrated embodiments have been shown in the drawings and are described below in detail. However, there is no intention to limit the scope of the invention to the specific form disclosed, but, on the contrary, the invention is to cover all modifications, alternative constructions, and equivalents falling within the spirit and scope of the invention as defined in the claims.

### Embodiment 1

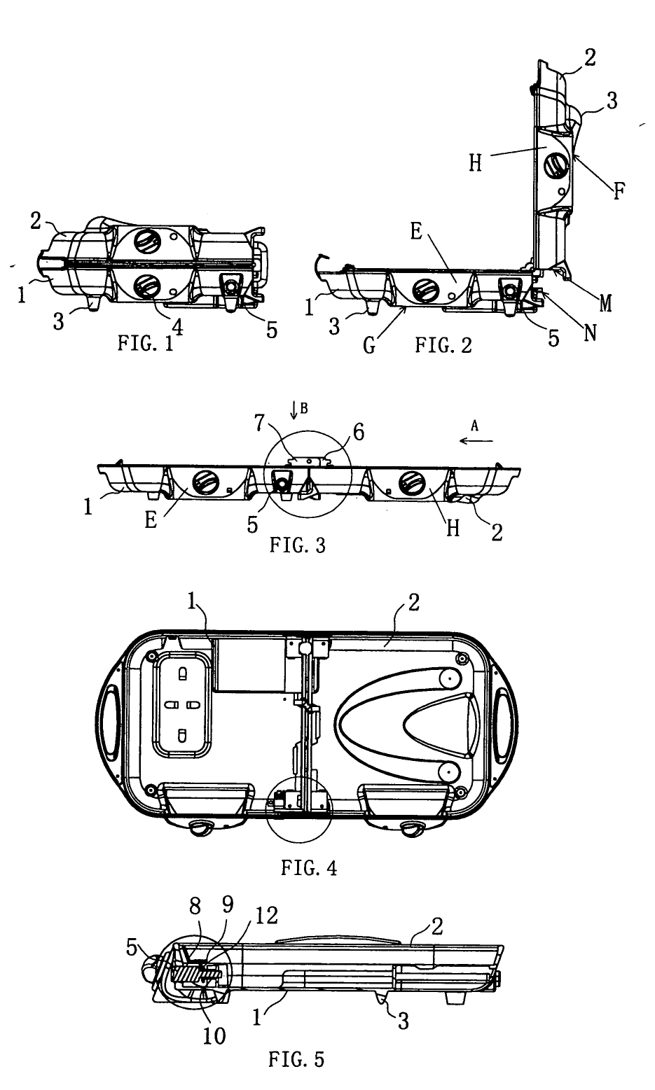

As shown in FIGS. 1 to 5, an embodiment of the locking device is shown. The locking device is for foldable rigid buckling packing housings applied in an electrical folding griddle. The locking device for foldable rigid buckling packing housings has a lower housing 1, an upper housing 2, a button 5, an upper housing hinge plate 6, a lower housing hinge plate 7 and a locking plate 8.

A hinge joint structure is installed between lower housing 1 and upper housing 2 to interconnect them with each other. The circle in FIG. 3 shows the hinge joint structure.

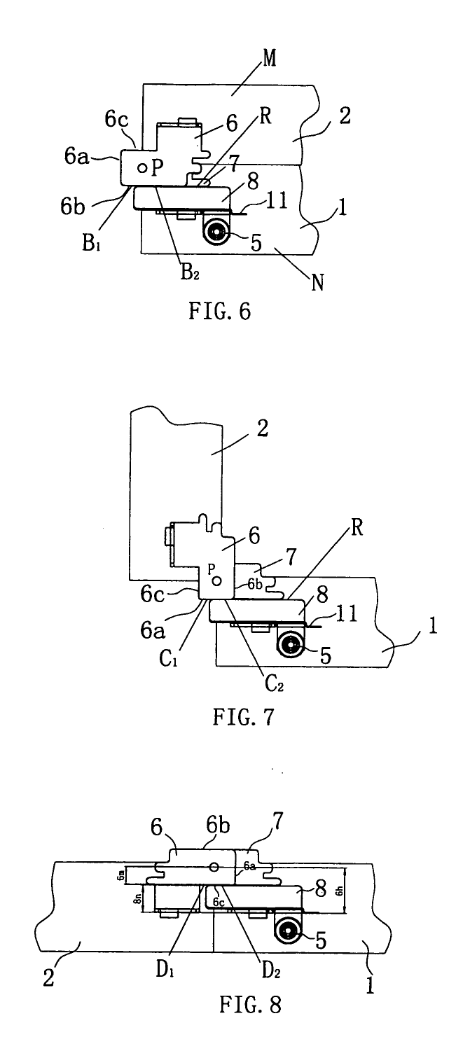

The hinge joint structure, shown in the circle in FIG. 3, is located between the lower housing 1 and the upper housing 2. The hinge joint structure is structured as following. An upper housing hinge plate 6 is attached on the upper housing 2 and an the lower housing hinge plate 7 on the lower housing 1. Upper housing hinge plate 6 is interconnected with lower housing hinge plate 7. A movable locking plate 8 is installed between the lower housing scaleboard and the fasten bar to lock the rotatable arms of the upper housing hinge plate 6 (refer to FIG. 6 to FIG. 8). The locking plate is linked to a button 5 on the sidewall of the lower housing. The button 5 has a resetting spring 10. The rotatable arms use the hinge point (P) of the hinge plate as a pivot. The rotatable arms are located at both sides of the hinge point (P) at B1 and B2. B1 and B2 show parts of the rotatable arms of hinge plate 6 as shown in FIG. 6 at a closed position. C1 and C2, in FIG. 7 show parts of the rotatable arms of hinge plate 6 at a half open position. D1 and D2, FIG. 8, show parts of the rotatable arms of hinge plate 6 when fully opened to a 180-degree position.

As shown in FIG. 5, guiding parts 9 comprises a lower housing hinge plate, a lower housing scaleboard and a fasten bar. The horizontal part of the “┐” shaping locking plate 8 fits between the fasten bar and the lower housing scaleboard; both the upper side and the lower side of the “┐” shaping locking plate 8 are restricted by the fasten bar and the lower housing scaleboard to make sure that it cannot move upwards or downwards, and its right and left sides are clipped inside the groove on the hinge plate, thus the “┐” shaping locking plate 8 can only move forward or backwards. The front part of button 5 which sticks into the housing has a step with a smaller diameter, which goes through the perpendicular wall of the “┐” shaping locking plate 8. The thicker end of button 5 sticks at the perpendicular wall of the locking plate 8. The thinner end of button 5 fits through the guiding hole on the baffle plate 12. Resetting spring 10 rings the button; there is an opening shown in FIG. 5, (the direction of FIG. 5 is perpendicular to that of FIG. 2 and FIG. 3) on the side wall of the joint surface between the lower housing 1 and the upper housing 2 (as M and N shown in FIG. 2) for hinge plates (6, 7) to rotate and protrude.

Now referring to FIG. 6 and FIG. 7. FIG. 6 is a block diagram illustrating the relative position of upper housing hinge plate 6 and locking plate 8 at closed position. FIG. 7 is a block diagram illustrating the relative position of upper housing hinge plate 6 and locking plate 8 at half open position. In embodiment 1, the upper housing hinge plate 6 is attached on the upper housing 2, and is interconnected with the lower housing hinge plate 7 attached on the lower housing 1. In this embodiment, the lower edge 6b of this upper housing hinge plate 6 is parallel to its upper edge 6c, and the inner edge 6a is perpendicular to the lower edge 6b.

Referring now to FIG. 8. FIG. 8 is a block diagram illustrating the relative position of the upper housing hinge plate 6 and the locking plate 8 in embodiment 1 and 3 while the locking device for foldable rigid buckling packing housings is fully opened to a 180-degree position, as shown in FIG. 3. The upper housing hinge plate 6 is attached on the upper housing 2, and is interconnected with the lower housing hinge plate 7 attached on the lower housing 1. In this embodiment, the lower edge 6b of this upper housing hinge plate 6 is parallel to its upper edge 6c, and the inner edge 6a is perpendicular to the lower edge 6b.

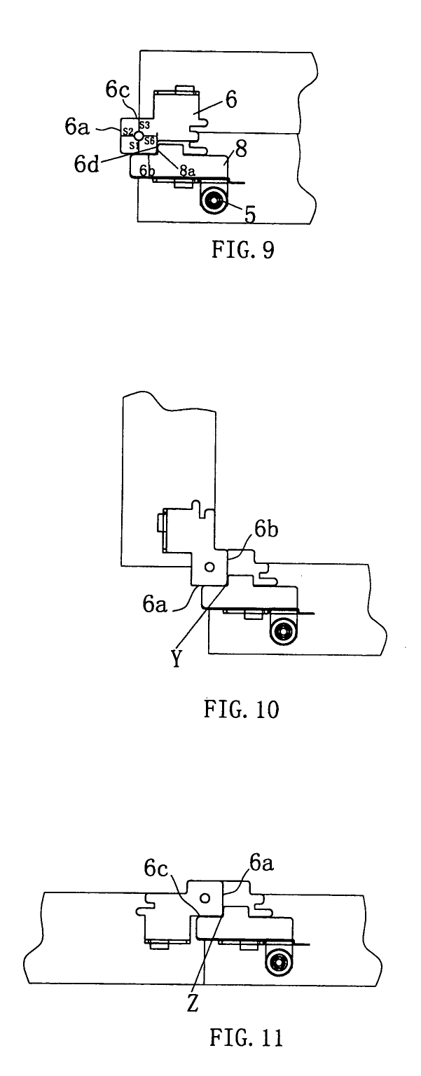

As shown in FIG. 8, the upper side of the locking plate 8 sticks at the edge of the upper housing hinge plate 6, which covers both sides (D1 and D2 as shown in FIG. 8) of the projection of the hinge point (P). The distance (S1 as shown in FIG. 9 and FIG. 10) between the hinge point (P) and the lower edge 6b of the upper housing hinge plate 6 is equal to the distances (S2 and S3 as shown in FIG. 9 and FIG. 10) from the hinge point (P) to the inner edge 6a and/or the upper edge 6c.

By pressing button 5 upper housing 2 can be rotated. The upper edge 6c of the upper housing hinge plate 6 is parallel to its lower edge 6b, and the distance (S3 as shown in the enlarged illustrating diagram of FIG. 11) from the hinge point (P) to the upper edge 6c is equal to the distance of (S1) from the hinge point (P) to the lower edge 6b, by releasing button 5 when the upper housing is opened to a 180-degree position with respect to the lower housing. The upper side (R) of the reset locking plate 8 can stick at the right and left sides (D1 and D2) of the projection of the hinge point of the upper edge 6c, and upper housing 2 can be locked at the opening position to a 180-degree position with respect to the lower housing.

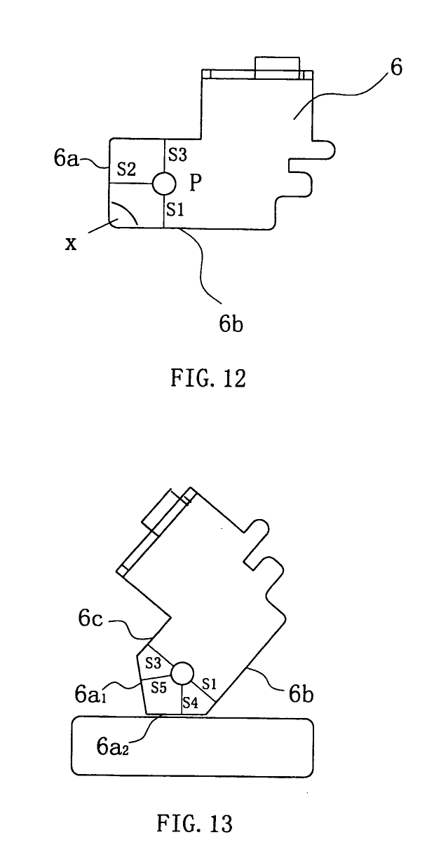

As shown in FIG. 12 and FIG. 13, the upper side of the locking plate 8 sticks at the side edge of the upper housing hinge plate 6 at the right and left sides (B1 and B2 as shown in FIG. 6, C1 and C2 as shown in FIG. 7, D1 and D1 as shown in FIG. 6) of the hinge point, The distance (S1 as shown in FIG. 9 and FIG. 10) between the hinge point (P) and the lower edge 6b of the upper housing hinge plate 6 is equal to the distances (S2 and S3 as shown in FIG. 9 and FIG. 10) from the hinge point (P) to the inner edge 6a and/or the upper edge 6c.

Referring to FIGS. 6, 7, 8, 12 and 13. During usage, when the upper housing 2 and the lower housing 1 are closed, the lower edge 6b of the upper housing hinge plate 6 sticks on the upper side of the locking plate 8 (as shown in FIG. 6). Because the locking plate 8 works on the edge of the upper housing hinge plate 6 at the right and left sides of the project of the hinge point (P), that is the rotatable arms of the upper housing hinge plate 6 cannot rotate (as shown in FIG. 6, the rotatable arms B1 and B2 sticks on the upper side of the locking plate 8 and cannot rotate either clockwise or anticlockwise), the upper housing 2 is locked at the closed position. Pressing the button 5 will push the locking plate 8 to move towards the inside and take (R) of the locking plate 8 off from lower edge (B1 and B2) of the upper housing hinge plate 6. The upper housing hinge plate 6 can rotate again and thus opens the upper housing 2. Because the distance (S2) from the hinge point (P) to the inner edge 6a equals the distance of (S1) from the hinge point (P) to the lower edge 6b, when releasing the button 5 and resetting the locking plate 8, the edges (C2 and C1) of the hinge plate inner edge 6a at the right and left sides of the hinge point (P) can stick on the (R) of the locking plate 8 (as shown in FIG. 7), thus making the rotatable arms (C1 and C2) unable to rotate either clockwise or anticlockwise. In this embodiment, the inner edge 6a is perpendicular to the lower edge 6b, so the upper housing 2 is locked at half open position with an opening angle of 90 degree.

As mentioned above, when the distance from the hinge point (P) to the inner edge 6a equals the distance from the hinge point (P) to the lower edge 6b (S2=S1), the upper housing hinge plate 6 can be locked at a half open position; the opening angle is decided by the angle between the inner edge 6a and the lower edge 6b (X as shown in FIG. 9). When the distance from the hinge point (P) to the upper edge 6c equals the distance from the hinge point (P) to the lower edge 6b (S3=S1), the upper housing hinge plate 6 can be locked at the fully open position. The opening angle is determined by the angle between the upper edge 6c and the lower edge 6b. Hence, in order to make the upper housing 2 lockable at one or more open position, at least one of the distances from the hinge point (P) to the inner edge 6a and from the hinge point (P) to the upper edge 6c (S2 and S3) needs to equal to that from the hinge point (P) to the lower edge 6b (S1). In this embodiment, both the distances (S2 and S3) from the hinge point (P) to the inner edge 6a and from the hinge point (P) to the upper edge 6c (S2 and S3) equal the distance from the hinge point (P) to the lower edge 6b (S1), so the upper housing 2 can be locked at two open positions.

It can be understood from this embodiment, if several inner edges (6a1 and 6a2 as shown in FIG. 12) with different angles to the lower edge 6b are set, and the distance (S4 and S5) from the hinge point (P) to each inner edge equals each other, the upper housing hinge plate 6 can be locked at several open positions with several different opening angles.

This embodiment of the invention is applied to the outer housings used for electrical folding griddles. There are heating boards installed both inside the lower housing and the upper housing. This part is common technique used in electrical griddles. Electrothermal components are installed between the lower housing 1, the upper housing 2 and the heating board. They are located below the heating board (not shown). The control knob 4 controlling the electrothermal components is installed on the outer side walls (E as shown in FIG. 2) of the lower housing 1 and the upper housing 2. Feet 3 are installed on both the bottom wall (G as shown in FIG. 2) of the lower housing 1 and the top wall (F as shown in FIG. 2) of the upper housing 2; when the upper housing 2 is fully opened to a 180-degree position with respect to the lower housing 1, feet 3 on both the outer walls of the upper housing 2 and the lower housing 1 stand on the supporting platform.

Electrical griddles employing the locking device for foldable rigid buckling packing housings of the present invention have advantages such as portability, conserving space, and facility of use. The upper housing and the lower housing can be locked in an open position, thus making it safe to operate.

### Embodiment 2

FIG. 9 to FIG. 11 are the block diagrams of embodiment 2 of the locking device for foldable rigid buckling packing housings.

The difference between this embodiment and the first embodiment is: the upper side of the locking plate 8 has a convex portion 8a at the site of the projection of the hinge point (P), while the lower edge 6b of upper housing hinge plate 6 has a concave portion 6d matching the convex portion 8a on the upper side of the locking plate. The distance from the hinge point (P) to the concave portion 6d is equal to the distances (S1, S2 and S3 as shown in the enlarged diagram of FIG. 9) from the hinge point (P) to the lower edge 6b, the inner edge 6a and the upper edge 6c.

When the upper housing 2 and the lower housing are closed, the upper side (R) of locking plate 8 locks the rotatable arms of the upper housing hinge plate 6 in both forward and backward direction. In addition, the convex portion 8a on the upper side (R) of locking plate 8 locks the concave portion 6d on the lower edge of the upper housing hinge plate 6, thus make the upper housing 2 locked more stably. Also, when the upper housing 2 and the lower housing 1 are opened at opening angles of 90 degree or 180 degree, the convex portion 8a on locking plate 8 can lock the joint site (Y as shown in FIG. 10) between the lower edge 6b and the inner edge 6a of the upper housing hinge plate 6 and the joint site (Z as shown in FIG. 11) between the upper edge 6c and the inner edge 6a of the upper housing hinge plate 6 respectively, thus locking the upper housing 2 more stably at the corresponding open position.

The functioning of the present invention is illustrated as following with reference to FIG. 6 to FIG. 13. When the upper housing 2 and the lower housing 1 are closed, locking plate 8 locks the rotatable arms (B1 and B2 as shown in FIG. 6) of the upper housing hinge plate 6 to stop them from rotating thereby locking the upper housing 2 and the lower housing 1 closed. When pressing the button 5, the locking plate 8 linked with the button 5 moves and releases the rotatable arms (C1 and C2 as shown in FIG. 7) of the upper housing hinge plate 6, thus enabling the upper housing hinge plate 6 to rotate. Releasing button 5 when the upper housing 2 opens to a certain angle, the button 5 will reset, so will the locking plate 8, and the locking plate 8 will lock the rotatable arms (D1 and D2 as shown in FIG. 8) of the upper housing hinge plate 6 to stop it from rotating, thus locking the upper housing 2 at open position. The present invention makes the foldable rigid buckling packing housings able to be locked at both a closed position and an open position, and makes the structure simple and the apparatus easy to use.

### Embodiment 3

FIGS. 1 to 5 illustrate the structure of a third embodiment. The present embodiment is a locking device for foldable rigid buckling packing housings applied in a electrical folding griddle, the locking device for foldable rigid buckling packing housings comprises a lower housing 1, an upper housing 2, a button 5, an upper housing hinge plate 6, a lower housing hinge plate 7 and a locking plate 8.

A hinge joint structure is installed between the lower housing 1 and the upper housing 2 to interconnect them with each other. The circle in FIG. 3 shows the hinge joint structure.

FIG. 6 shows the relative positions of the upper housing hinge plate 6 and the locking plate 8 in the locking device for foldable rigid buckling packing housings applied in the electrical folding griddle. The upper housing hinge plate 6 is attached on the upper housing 2 and on lower housing hinge plate 7 on the lower housing 1. The upper housing hinge plate 6 is interconnected with the lower housing hinge plate 7. A movable locking plate 8 is installed between the lower housing scaleboard and the fasten bar to lock the rotatable arms of the upper housing hinge plate 6. The distance from the hinge point to the upper side of the locking plate is 6m. The distance from the upper side of the locking plate to the lower housing scaleboard is 8n. The distance from the hinge point to the lower housing scaleboard is 6h. The sum of the distance (6m) from the hinge point to the upper side of the locking plate and that (8n) from the upper side of the locking plate to the lower housing scaleboard is equal to the distance (6h) from the hinge point to the lower housing scaleboard.

Although preferred embodiments of the present invention have been described for illustrative purposes, those skilled in the art will understand that various modifications, additions and substitutions are possible, without departing from the scope and spirit of the invention as disclosed in the accompanying claims.

1. A locking device for foldable rigid buckling packing housings, comprising a lower housing, an upper housing, a button, an upper housing hinge plate, a lower housing hinge plate, and a locking plate;
wherein the lower housing and the upper housing are interconnected by hinge plates; wherein the structure of the hinges between the lower housing and the upper housing is as follows: the upper housing hinge plate is attached on the upper housing and interconnected with the lower housing hinge plate; a movable locking plate is attached on the lower housing to lock the rotatable arms of the upper housing hinge plate; the locking plate is linked with the button on the side wall of the lower housing; and the button has a resetting spring.

2. The locking device for foldable rigid buckling packing housings as claimed in claim 1, wherein the upper side of the said locking plate sticks at the lower edge of the upper housing hinge plate, which covers the right and left sides of the projection of the hinge point, wherein the distance between the hinge point and the lower edge of the upper housing hinge plate is equals to the distances from the hinge point to the inner edge and/or the upper edge.

3. The locking device for foldable rigid buckling packing housings as claimed in claim 2, wherein the said lower edge of the upper housing hinge plate is parallel to said upper edge of the upper housing plate, while the inner edge is perpendicular to said lower edge.

4. The locking device for foldable rigid buckling packing housings as claimed in claim 3, wherein the upper side of the said locking plate has a convex portion at the site of the projection of the hinge point, while the lower edge of upper housing hinge plate has a concave portion matching the convex portion on the upper side of the locking plate; the distance from the hinge point to the concave portion is equal to the distances from the hinge point to the lower edge, the hinge point to the inner edge and the hinge point to the upper edge.

5. The locking device for foldable rigid buckling packing housings as claimed in claim 1, wherein the sum of distance from hinge point of said locking plate to its upper side and that from the upper side of the locking plate to the lower housing scaleboard equals the distance from the hinge point to the lower housing scaleboard.

6. The locking device for foldable rigid buckling packing housings as claimed in claims 1, 2, 3 or 4, wherein a heating board is installed between said lower housing and upper housing; electrothermal components are installed between the heating board and the housings; a control knob is installed on the side walls of the upper housing and the lower housing; and feet are installed on the bottom wall of the lower housing and the top wall of the upper housing.
